(19) United States
(12) Patent Application Publication
(10) Pub. No.: US 2017/0218576 A1
(43) Pub. Date: Aug. 3, 2017

(54) VIBRATORY HEAD FOR A CONCRETE SCREED HAVING INTERCHANGEABLE ECCENTRICS

(71) Applicant: Joseph W. LINDLEY, Paducah, KY (US)

(72) Inventor: Joseph W. LINDLEY, Paducah, KY (US)

(21) Appl. No.: 15/417,537

(22) Filed: Jan. 27, 2017

Related U.S. Application Data
(60) Provisional application No. 62/288,836, filed on Jan. 29, 2016.

(51) Int. Cl. E01C 19/40; E04F 21/24; B06B 1/16; E04G 21/06

(52) U.S. Cl. CPC E01C 19/402; E04G 21/066; E04F 21/242; B06B 1/163

(57) ABSTRACT

A vibratory assembly has a power source with a rotational output, an implement configured to work uncured concrete, and a vibratory head means for receiving a rotational input from the power source and converting the input from the power source into mechanical oscillation and to transfer the mechanical oscillation to the implement.

### CROSS-REFERENCE TO RELATED APPLICATIONS

This application claims priority under 35 U.S.C. §119(e) to U.S. Provisional Application Ser. No. 62/288,836, filed Jan. 29, 2016, which is incorporated herein by reference in its entirety.

### BACKGROUND

The present disclosure relates to powered concrete vibrators. More specifically, the present disclosure relates to concrete vibrators powered by power tools.

Power tools come in a variety of shapes and sizes and may be used for a variety of purposes. For example, there are concrete-finishing tools (e.g., screeds, edgers, groovers, floats, consolidators) and yard tools (e.g., edgers, hedge trimmers, weed cutters), to name just a few.

Concrete vibrators are powered by rotary power units. Effective vibration of concrete requires sufficient rotary speed to rotate a vibratory element, such as an eccentric load, at a rate sufficient to develop vibration sufficient to consolidate concrete.

### SUMMARY

The present application discloses one or more of the features recited in the appended claims and/or the following features which, alone or in any combination, may comprise patentable subject matter:

According to a first aspect of the present disclosure, a vibratory assembly comprises a power source with a rotational output, an implement configured to work uncured concrete, and a vibratory head for receiving a rotational input from the power source and converting the input from the power source into mechanical oscillation and to transfer the mechanical oscillation to the implement, the vibratory head having a removable eccentric load.

In some embodiments, the eccentric load is rotated by the rotational input to generate the mechanical oscillation.

In some embodiments, the eccentric load rotates at substantially the same rate as the rotational input received from the power source.

In some embodiments, the vibratory head comprises a kit including interchangeable eccentric loads of different sizes.

In some embodiments, the vibratory head comprises a kit including interchangeable eccentric loads of different masses.

In some embodiments, the vibratory head comprises a kit including interchangeable eccentric loads of different diameters.

In some embodiments, the vibratory assembly further comprises a rigid handle assembly that includes a passageway for transferring rotational output from the power source to the rotational input into the vibratory head.

In some embodiments, the vibratory assembly further comprises a rigid handle that includes a gripping structure and a flexible drive shaft.

In some embodiments, the vibratory assembly further comprises a handle that includes a gripping structure, the gripping structure including a passageway for transferring rotational output from the power source to the rotational input into the vibratory head.

According to a second aspect of the present disclosure, a vibratory assembly comprises a power source with a rotational output, an implement configured to work uncured concrete, a handle interconnecting the implement and the power source, and a vibratory head receiving a rotational input from the power source and converting the input from the power source into mechanical oscillation and to transfer the mechanical oscillation to the implement, the vibratory head including a removable eccentric load.

In some embodiments, the vibratory assembly further comprises a handle that includes a gripping structure, the gripping structure including a passageway for transferring rotational output from the power source to the rotational input into the vibratory head.

In some embodiments, the eccentric load is rotated by the rotational input to generate the mechanical oscillation.

In some embodiments, the eccentric load rotates at substantially the same rate as the rotational input received from the power source.

In some embodiments, the vibratory head comprises a kit including interchangeable eccentrics of different sizes.

In some embodiments, the vibratory head comprises a kit including interchangeable eccentric loads of different masses.

In some embodiments, the vibratory head means comprises a kit including interchangeable eccentrics of different diameters.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a first embodiment of a tool having a two handle screed frame with a cordless power drill and a vibrator coupled to a screed blade;

FIG. 2 is a perspective view of a second embodiment of a tool having a single-handle floating screed frame with a cordless power drill and a vibrator coupled to a screed plate;

FIGS. 3-4 are detailed views of the second embodiment showing a coupling mechanism of the power drill and an elongated shaft;

FIG. 5 is an elevation view of an alternative embodiment of an elongated shaft;

FIGS. 6-7 are perspective views of the vibrator of the second embodiment showing two different sizes of eccentric load, which is protected in a housing; and

FIGS. 8-9 are side views of the housing of the second embodiment.

### DETAILED DESCRIPTION OF THE DRAWINGS

For the purposes of promoting an understanding of the principles of the invention, reference will now be made to one or more illustrative embodiments shown in the drawings and specific language will be used to describe the same. It will nevertheless be understood that no limitation of the scope of the invention is thereby intended.

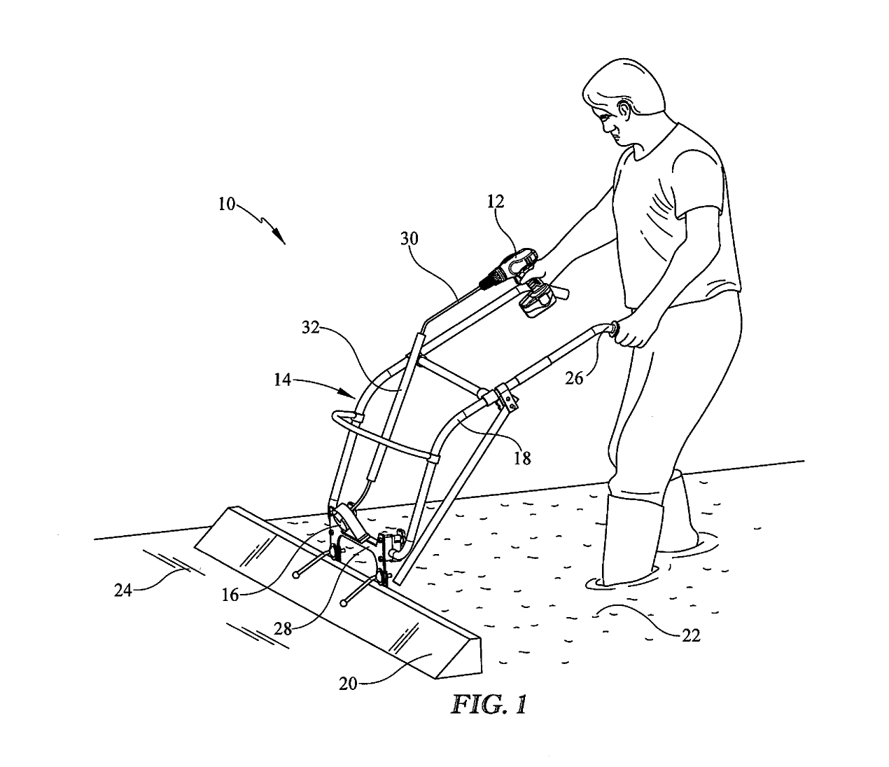

According to the present disclosure, a tool 10 is adapted for use with a rotary power tool, illustratively embodied as a power drill 12, to perform an operation on a workpiece as shown, for example, in FIG. 1. The tool 10 includes a movable component 16 adapted to facilitate performance of an operation on a workpiece, such as uncured concrete, for example. The drill 12 acts as a power source for the tool 10. Further, the drill 12 can be uncoupled from the tool 10 to allow use of the drill 12 for another purpose or perhaps to facilitate storage of tool 10. In the illustrative embodiment, the drill 12 is embodied as a DC powered cordless drill 12 with a battery. It should be appreciated that the drill 12 may be embodied as an AC powered electric drill. It should be appreciated that the drill 12 may be cordless or corded.

The tool 10 may be configured as any number of tools operable by a power source. For example, the tool 10 may be a concrete-finishing tool such as, for example, a concrete screed, concrete edger, concrete groover, concrete float, or concrete consolidator. In such a case, the workpiece may be freshly poured or otherwise uncured concrete and movable component 16 may be a vibrator having, for example, an eccentric load or other vibratory element that induces vibration of an implement 20 of the tool 10 in response to operation of drill 12 during screeding, edging, grooving, floating, consolidation, or performance of some other operation on the concrete. In other embodiments, tool 10 may be a yard tool such as, for example, a grass edger, hedge trimmer, or weed cutter. Movable component 16 may thus be configured as any of a variety of cutting elements for workpieces such as grass, bushes, weeds, or the like. The tool 10 may thus be configured to be powered by drill 12 to accomplish any of a variety of purposes.

Referring to FIG. 1, the drill 12 may be used with a two-handle screed 14 to power vibration of a vibrator 16 of screed 14. The screed 14 includes a frame 18 coupled to the implement, which is illustratively embodied as a screed blade 20 that a user slides over the top of uncured concrete 22 to strike off extra concrete and screed the uncured to a finished surface 24. The vibrator 16 promotes such use of screed blade 20 and further promotes consolidation of the concrete 22. When coupled to the screed 14, a handle 26 of drill 12 may act as the left or right handle of the screed 14. Rotary motion from the drill 12 is transferred through a flexible cable 30 to a vibratory head 28 coupled to screed blade 20 to transfer vibration to the screed blade 20 to consolidate concrete. The flexible cable 30 may be partially or fully encased by a casing 32 which is coupled to the frame 18 for protection. The casing 32 is a rigid hollow cylindrical tube having an inside diameter sufficient to receive the flexible cable 30 that extends from the drill 12 to the vibrator 16. It should be appreciated that, in some embodiments, the casing 132 may be flexible.

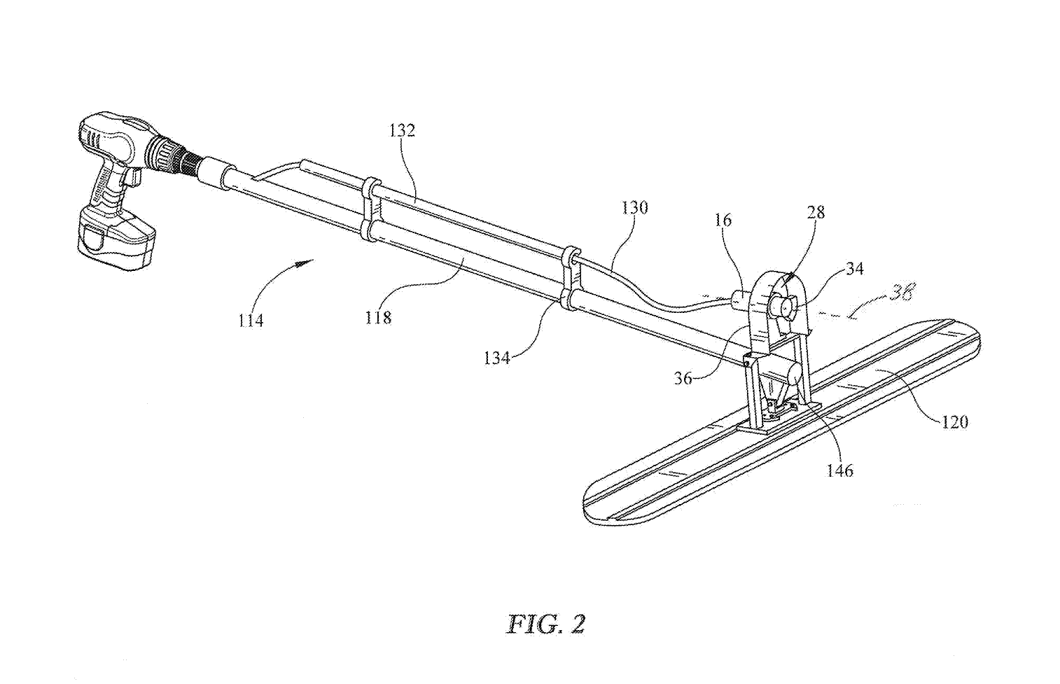

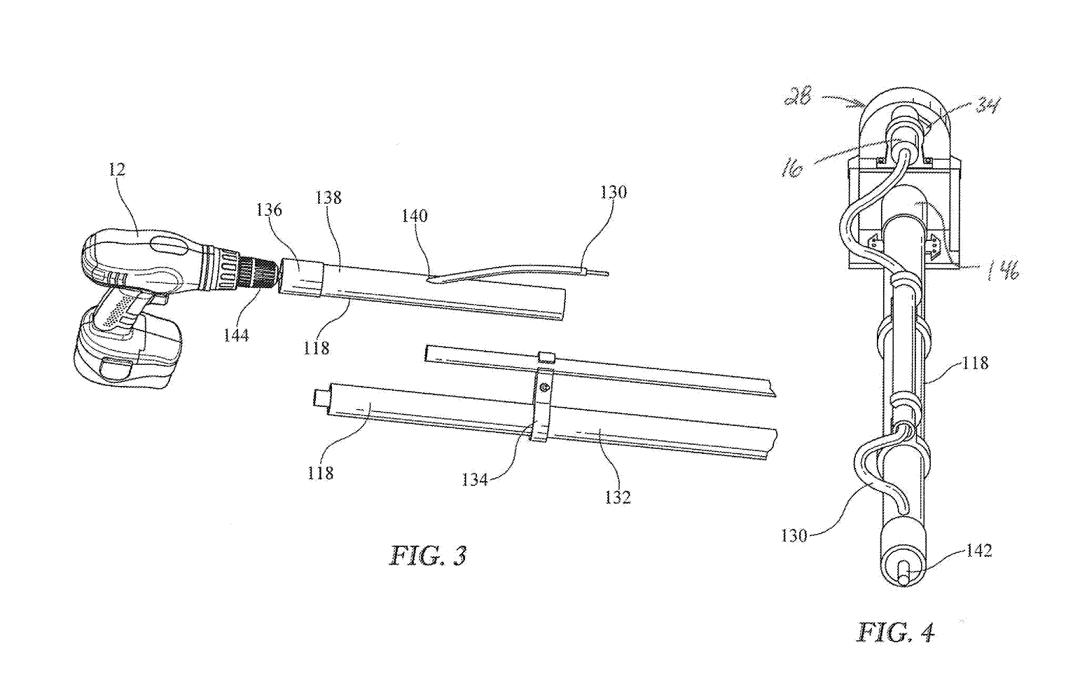

Similarly, in an alternative embodiment as shown in FIG. 2, the drill 12 may be used with a single-handle floating screed 114, also known as a power float, to power vibration of a vibrator 16 of floating screed 114 to remove surface imperfection. The floating screed 114 is constructed similarly to the screed 14 of FIG. 1. The floating screed 114 includes an elongated shaft 118 coupled to a screed plate 120. The elongated shaft 118 provides a structure that supports the drill 12 at a proximal end 138 of the elongated shaft 118 and the screed plate 120 at a distal end 146 of the elongated shaft 118. The elongated shaft 118 further provides a grip to control a pitch angle of the screed plate 120. When the drill 12 is coupled to the floating screed 114, a handle 26 of drill 12 may act as the left or right handle of the floating screed 114. Rotary motion from the drill 12 is transferred through a flexible cable 130 to the vibratory head 28 coupled to screed plate 120 to transfer vibration to the screed plate 120 to consolidate concrete. The flexible cable 130 may be partially or fully encased by a casing 132. The casing 132 is coupled to the elongated shaft 118 via a plurality of clamps 134 as shown in detail in FIG. 3.

The elongated shaft 118 is a hollow cylindrical tube having an inside diameter sufficient to receive a portion of the flexible cable 130 that extends from the drill 12 to the vibrator 16. The elongated shaft 118 includes a hole 140 near the proximal end 138 of the elongated shaft 118 such that the flexible cable 130 extends from the proximal end 138 of the elongated shaft118 along the hollow cylindrical tube, exits outwardly through the hole 140, and extends through the casing 132 to be coupled to the vibrator 16. It should be appreciated that, in some embodiments, the casing 132 may be flexible or rigid.

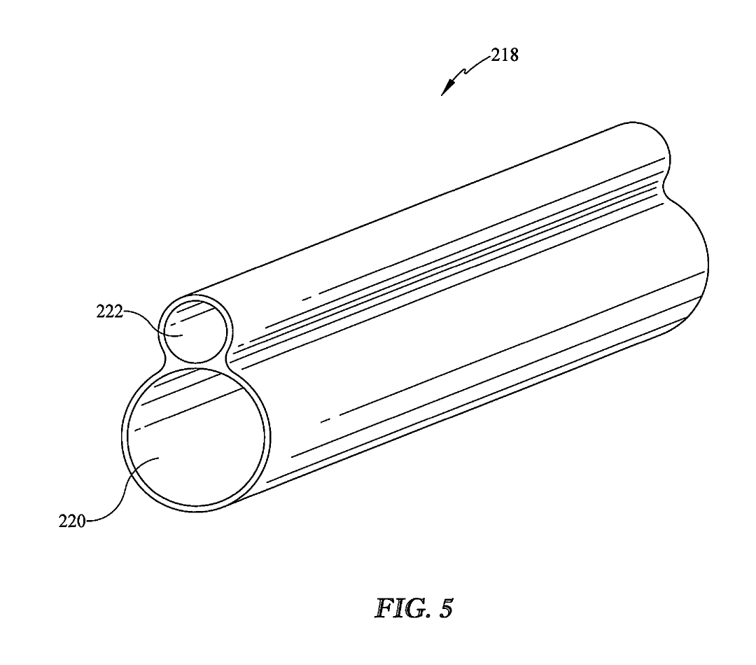

In some embodiments, an elongated shaft 218 includes a monolithic body to provide support and to encase the flexible cable 130 as shown in FIG. 5. The elongated shaft 218 includes a first tube 220 and a second hollow cylindrical tube 222. The first tube 220 has a generally hollow cylindrical shape and is configured to provide a structure that supports the drill12 at a proximal end of the first tube 220 and the screed plate 120 at a distal end of the first tube 220. The second tube 222 has a generally hollow cylindrical shape having a radius smaller than a radius of the first tube 220. The second tube 222 is configured to receive the flexible cable 130 which extends from the drill 12 to the vibrator head 28. In such an embodiment, the flexible cable 130 need not exit the elongated shaft 218 to extend along the side of the elongated shaft, instead the flexible cable 130 extends inside of the second tube 222. The particular shape of the elongated shaft 218 provides a positive ergonomic grip and gives a user more torque to reduce the energy required to control the pitch angle of the tool 10. The positive ergonomic grip provides much traction even to sweaty or greasy hands.

Referring back to FIGS. 3-4, the elongated shaft 118 is connected to the drill 12 by a connector 136 at the proximal end 138 of the elongated shaft 118. The connector 136 includes a drill bit 142 that is configured to engage a chuck 144 of the drill 12 to allow rotation of a rotational output of the drill 12 to be transferred to the vibrator 16 via the flexible cable 130. In other words, the output speed of drill 12 directly correlates to the rotational speed of the vibrator 16.

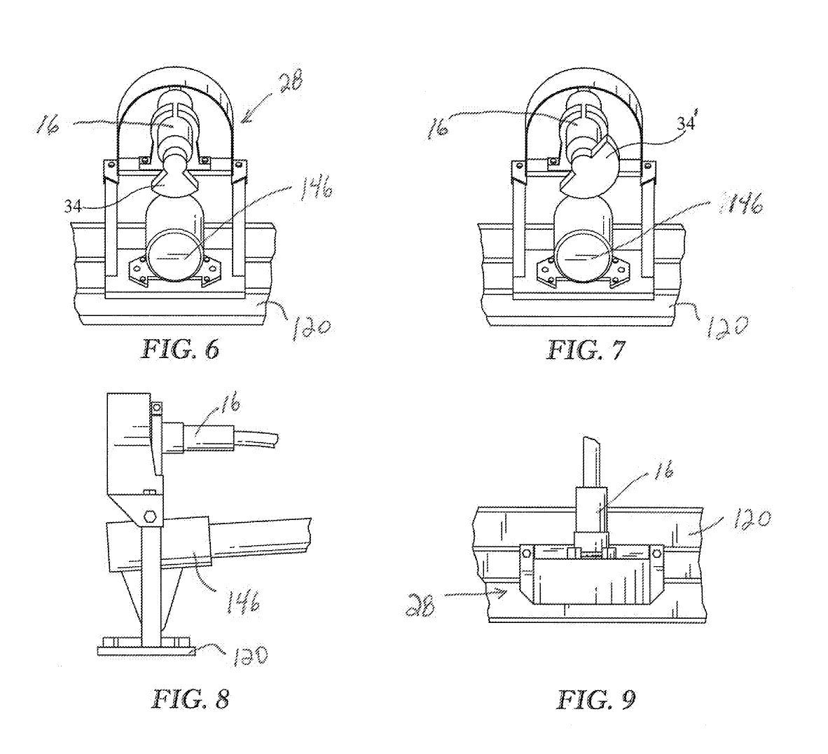

Referring now to FIGS. 6-9, the vibrator 16 is surrounded by a housing 36 to protect the eccentric load 34 and a removable end cap (not shown) is coupled to an end of the housing 36 to close the end thereof. The housing 36 further couples the vibrator 16 to the distal end 146 of the elongated shaft 114. The vibratory head 28 of the vibrator 16 includes an eccentric load 34. The eccentric load 34 is coupled to the vibratory head 28 via a connector (not shown) for rotation in a liner (not shown).

In use, when the drill 12 is turned on, the rotation from the drill 12 is transferred to the eccentric load 34 to induce vibration at the vibratory head 28 which is then imparted to the screed plate 120. In the illustrated embodiment, the eccentric load 34 may be exchanged to a different size of eccentric load 34 to generate varying amplitude of vibration because the different size of eccentric load 34 creates different amplitude of vibration. Varying the size of the eccentric load 34 may be accomplished by changing the shape of the eccentric load 34, the diameter of the eccentric load 34, the mass of the eccentric load 34, the location of the center of mass of the eccentric load 34 relative to an axis of rotation 38 of the eccentric load 34. The use of much larger eccentric load 34 will consolidate larger areas of concrete much faster. By using the different size/weight of the eccentric load 34, the vibrator 16 can generate wider spectrum of vibration amplitudes using a limited speed of the drill 12, thus, eliminating the need of a speed modifier, such as a gear box, to increase or decrease the output speed of the drill 12.

Referring to FIGS. 5 and 6, it can be seen that the eccentric load 34 shown in FIG. 5 has a smaller mass than an eccentric load 34′ shown in FIG. 6. In use, a user maintains a kit that has multiple eccentric loads, such as eccentric loads 34 and 34′, which can be quickly interchanged as the characteristics of the uncured concrete 22 changes. By interchanging the eccentrics loads, the performance of the tool 10 can be adapted to a particular use case.

Although certain illustrative embodiments and graphical illustrations have been described in detail above, variations and modifications exist within the scope and spirit of this disclosure as described and as defined in the following claims.

1. A vibratory assembly comprising
a power source with a rotational output,
an implement configured to work uncured concrete, and
a vibratory head for receiving a rotational input from the power source and converting the input from the power source into mechanical oscillation and to transfer the mechanical oscillation to the implement, the vibratory head having a removable eccentric load.

2. The vibratory assembly of claim 1, wherein the eccentric load is rotated by the rotational input to generate the mechanical oscillation.

3. The vibratory assembly of claim 1, wherein the eccentric load rotates at substantially the same rate as the rotational input received from the power source.

4. The vibratory assembly of claim 1, wherein the vibratory head comprises a kit including interchangeable eccentric loads of different sizes.

5. The vibratory assembly of claim 1, wherein the vibratory head comprises a kit including interchangeable eccentric loads of different masses.

6. The vibratory assembly of claim 1, wherein the vibratory head comprises a kit including interchangeable eccentric loads of different diameters.

7. The vibratory assembly of claim 1, wherein the vibratory assembly further comprises a rigid handle assembly that includes a passageway for transferring rotational output from the power source to the rotational input into the vibratory head.

8. The vibratory assembly of claim 1, wherein the vibratory assembly further comprises a rigid handle that includes a gripping structure and a flexible drive shaft.

9. The vibratory assembly of claim 1, wherein the vibratory assembly further comprises a handle that includes a gripping structure, the gripping structure including a passageway for transferring rotational output from the power source to the rotational input into the vibratory head.

10. A vibratory assembly comprising
a power source with a rotational output,
an implement configured to work uncured concrete,
a handle interconnecting the implement and the power source, and
a vibratory head receiving a rotational input from the power source and converting the input from the power source into mechanical oscillation and to transfer the mechanical oscillation to the implement, the vibratory head including a removable eccentric load.

11. The vibratory assembly of claim 10, wherein the vibratory assembly further comprises a handle that includes a gripping structure, the gripping structure including a passageway for transferring rotational output from the power source to the rotational input into the vibratory head.

12. The vibratory assembly of any of claims 11, wherein the eccentric load is rotated by the rotational input to generate the mechanical oscillation.

13. The vibratory assembly of any of claims 12, wherein the eccentric load rotates at substantially the same rate as the rotational input received from the power source.

14. The vibratory assembly of any of claims 13, wherein the vibratory head comprises a kit including interchangeable eccentrics of different sizes.

15. The vibratory assembly of claim 13, wherein the vibratory head comprises a kit including interchangeable eccentric loads of different masses.

16. The vibratory assembly of claim 13, wherein the vibratory head means comprises a kit including interchangeable eccentrics of different diameters.
